(19) United States
(12) Patent Application Publication
(10) Pub. No.: US 2024/0159614 A1
(43) Pub. Date: May 16, 2024

(54) IoT alarm for failures in fluid systems

(71) Applicants: Giorgio Carlo Mario RUPNIK, Genoa (IT); Carlo Francesco Emerico RUPNIK, Budva (ME)

(72) Inventors: Giorgio Carlo Mario RUPNIK, Genoa (IT); Carlo Francesco Emerico RUPNIK, Budva (ME)

(21) Appl. No.: 17/986,045

(22) Filed: Nov. 14, 2022

(51) Int. Cl. G01M 3/18; G08B 21/20

(52) U.S. Cl. CPC G01M 3/184; G08B 21/20

(57) ABSTRACT

An alerting 24/7 safety device for industrial soft-seated fluid valves, capable to detect immediately and remotely any damage or breakage of internal valve components. Such a system allows the essential technical intervention time to avoid leakages of the harmful (poison or caustic, with dangerous pressures or temperatures) media within the plants.

The inventive step gap is related to the strong improvement of the safety characteristics of the workplaces, in terms of health of the people, environment aspects and attention for the business continuity.

### CROSS-REFERENCE TO RELATED APPLICATIONS

Present technology comprehends many types of soft-seated valves, including ball, butterfly, check, globe, gate, plug, needle, pinch, diaphragm and other ones. Among these, diaphragm valves were patented by Philip K. Saunders (GB319936A—1928, October 3rd): since that date many patents have been filed in such field but none of them seem to have dealt with the extra safety device that today is requested for a provisional grant. Moreover, with priority 8-8-1994, the inventors filed the patent WO1996005456A1 related to a new kind of sealed topwork for diaphragm valves, characterized by simplicity, easy manufacture and flexibility in application and replacement.

With reference to the above, the inventive core of this new device grounds on the immediate information of a malfunctioning of the fluid system; such immediacy is of crucial importance as it is the only way to protect workers and environment from dangerous harm as facts are happening in a timely manner. Moreover, this device helps in preserving the plant, increasing the business continuity parameters.

With reference to the related applications it is worth mentioning the U.S. Pat. No. 8,794,595B2 (US879): although it precisely focused on the diaphragm element of the diaphragm valve.

These following lines will explain why such related patent US879 cannot be considered prior art with respect to the current application.

US879 proposes a Diaphragm valve with internal leak detection and improved external leakage sealing performance while today's applicant proposes an IoT alarm for failure in fluid systems: the title itself highlights the main dichotomy existing in the two ideas.

US879 is in fact dedicated solely to the diaphragm valve or, rather, to the diaphragm itself, while today's application embraces a much wider field of application and above all does not intervene on the diaphragm which constitutes the main element of this special valve.

Therefore, if the US879 is grounded on the diaphragm, today's application acts directly in the control chamber, above said diaphragm, if it is a diaphragm valve, but in other various situations if it were other types of valve: pinch, ball, globe, gate, plug, needle, non-return, just to name a few of the main ones.

The differences are conceptual, functional, economic and industrial.

Conceptual: for the current application it is a question of working in another environment, of having solid mechanical walls, firmly fixed physical transducers, whilst the use of elastomers is not considered as a central issue, but the source of the malfunctioning of the valve. The only importance of the diaphragm itself is of no interest in this safety system except when it degrades to failure due to wear, overpressure, premature chemical corrosion or a combination of these. For US879 instead, the diaphragm is more than a key point: the whole patent is grounded there.

Functional: in diaphragm valves, this diaphragm element is of crucial importance: the most stressed part of the vale; therefore, modifying it to include control systems in it as US879 is doing, will weaken it and/or compromise its operation. When the valves were to work with dosing or pulsed functions, this diaphragm would be extremely stressed, shortening its expected life. Of course the current application doesn't face such kind of problems.

Economic: the adoption of the US879 patent entails the obligation to adopt diaphragms of a special type that are certainly more expensive, even more than 10 times the normal or existing one, reducing the competitive choices offered by the various (many) suppliers of diaphragms: in other words, it deals with the reduction of the commercial offer and the obligatory nature of the factual choice.

Industrial: the diaphragm is considered the most worn part of the valve, therefore the part subject to very frequent replacements. The use of this US879 system would involve unbearable costs for the majority of industrial users.

One of the advantages of today's application that cannot be performed by US879 is to be able to retrofit a functioning valve mounted on the industrial line: this even without the need to interrupt the flows and stop the plants.

The completely sealed valve is a real grant towards hazards as the alert will be providing enough time to solve the problematic spill risk.

The transducers are commercial ones, very popular, therefore easy to access and low cost.

Scope of application: another important inventive step lies precisely in the purpose of the application. When compared with the US879 it is noted that the current arrangement is not limited to diaphragm valves or rather to a specific diaphragm valve but is applicable to all those valves that are equipped with a separate chamber, even very small, between the area of the flow under pressure and the control organs or mechanisms: everything is aimed at the prevention and safety of work and plants, especially those with a high risk of pollution or hazard.

### BACKGROUND OF THE INVENTION

Diaphragm valves are an essential device for pharma and chemical plants. Their features comprehend the separation of the intercepted media from the operating mechanism of the valves, granting safety and high hygienic standards.

Great concern is represented by the risk of rupture of the diaphragm which could eventually provoke damages to people, plants and environment.

Since decades the major chemical corporations have taken precautions by installing only diaphragm valves with sealed top-works on those lines particularly critical for means or conditions, so as to grant a major level of safety for human beings and the environment.

In facts, if a diaphragm breaks inside a sealed topwork, nobody can predict the harmful leakage or dispersion or non closure of the valve until a major damage occurs.

The topwork sealing could in fact collapse a short time after the diaphragm brake, with nobody having advise of such occurrence.

The problem to be solved was represented by the timely knowledge of a failure, so as to have enough time to prevent potential disasters.

Also the US EPA recalls the importance in its “Prevention Reference Manual” 2000: “Control Technologies Volume 1.

Prevention and Protection Technologies for Controlling Accidental Releases of Air Toxics”; at page 198, speaking of diaphragm valves it is possible to read verbatim: “they should be equipped with packing around the stem.” to avoid having “the valve will leak with little or no constriction”.

The problem that remained to be solved was represented by the lack of monitoring of these valves and, even with valves classified as “tight-sealed”, the disaster could still have occurred because no one was aware of the defiance of the seals until the actual leakage of the toxic materials.

This problem is more evident in diaphragm and (encapsulated) pinch valves, but it is cross-spread in the whole field of fluid valves.

The system presented today can be applied to almost all types of intercepting valves.

### BRIEF SUMMARY OF THE INVENTION

The invention is particularly related to a top-work of a fluid valve, sealed or unsealed, manual or actuated with any kind of force.

The arrangement consists of manufacturing a valve topwork provided with a command which includes a sensor capable of detecting the change of a physical condition occurring inside the valve.

Generally, the operation of diaphragm valves consist, starting from the first element behind the diaphragm, by a compressor capable of distributing the closing force over the entire upper surface of the diaphragm, which compressor is in-turn pushed by a stem connected to a force system, manual or actuated by automatic systems.

The sensor is preferably powered autonomously such as a battery or other arrangements, so as to grant continuous functionality of the device.

The sensor is in direct contact with an internal chamber of the valve, so as to detect changes inside it.

The sensor is then connected with a wire or wireless system to a supervision or to any other device capable of providing information to the users.

If something like a diaphragm rupture or a seal leakage occurs, the system will be able to alert any device connected to it, even in an automatic way such as a retro-action on the plant or on other devices.

### DETAILED DESCRIPTION OF THE INVENTION

The device is composed of an operating topwork capable of operating a fluid valve, and a sensor capable of detecting physical changes inside such an arrangement. Such an operating arrangement can also be classified as a “valve actuator” with force provided by external means such as air, electricity, or any mechanical mean, also self operated or by a hand operating system. Such operating topwork may be any existing one, mounted on or part of a valve, or it can be added to any existing valve device.

The sensor to be applied to such bonnet or actuator is represented by any device which air-tightly connects the internal environment of such components to the external world; such sensor could be able to detect differences in pressure, temperature, humidity, moisture, gasses, PH, liquids, or any other detectable data, such as the biological ones, capable to be detected by commercial and experimental probes.

Once the detection signal is gathered by the sensor, this is transmitted elsewhere with the transmission system provided inside or around the sensor itself.

The idea is to obtain a small device, also autonomously powered by battery, light or other physical means, to work also if the central system of the plant in which the device is installed, turns into failure.

A standard arrangement could therefore comprehend a sensor, a power supply, a transmitter and even a tuned specific receiver if needed; of course the alerting signals can also easily be forwarded to smart-phones or other similar apparatus.

Such system made by topwork ad sensor will immediately act if the diaphragm, gasket, gland-pack, o-ring or layer, which is separating the topwork from the valve body, brakes or starts leaking for any kind of permeability: by permeability, beside gasses and liquids, it should also be comprehended light and temperature as both of them are capable to hold energetic values. Permeability of UV light, i.e. could lead in a short time to a diaphragm leakage or breakage.

These leakages may occur with any kind of valve but this system is designed to allow an intervention before an irreparable spill may occur, in a way to discourage a major disaster; this meaning that the system will necessarily need to be placed in between the seal separating the fluid from the interception system (diaphragm ie) and the seal which is separating the topwork to the external environment.

This means that the best combination for this device is the one with valves which are tight-sealed towards the environment: when the alarm is activated there will be the time for stopping the system and replacing the festered diaphragm with a new one without major damages.

### Examples of how it Will be Used

Primarily diaphragm and pinch valves, as well as soft seated valves, can encounter significant problems during their functioning installation in plants or systems and, one of these, is the rupture/failure of the elastomer or polymer parts.

The consequences are and have been of various kinds, both economic and for the health of the operators.

It happens, and happened, that a failure of such kind causes a disaster, provoking the destruction of huge quantities of goods but, worse, it causes human deaths and medical disabilities.

For example, a plant with hydro-sulfuric acid in its lines is a very common situation although its caustic media is an extremely dangerous matter.

But it can happen that the diaphragm or other seals break for inappropriate use in time or for improper replacement of them: these are two common situations although not so advertised; often products inside the line are also promoters of terrific explosions with poison fall-outs.

If this happens with highly hazardous products, volatile and tremendously poisonous, the problem could raise values of a huge concern.

Chemical and biotechnology-pharmaceutical companies would be the most interested in such kind of application, although the entire industry world could find important benefits in its application, even to control compressed air losses.

Economically, it should be relevant to the expected reduction of insurance fees, both the generic ones for damages to plant and environment and those dedicated to labor incidents, especially the fatal ones.

1. A protection system aimed to detect instantly, with appropriate sensors, the happening of a leakage or an internal failure within a valve for fluids, so as to send an alert, with or without wires, to a monitoring device which, in turn, may activate retro-action controls or other functions.

2. The system may be autonomously powered and use any kind of sensor capable of handling any physical value useful to be detected.

3. The system may use any kind of transmitting system, wired and wireless, therefore comprehending transmitter and receivers systems.
